(19) United States
(12) Patent Application Publication
(10) Pub. No.: US 2010/0086708 A1
(43) Pub. Date: Apr. 8, 2010

(54) BIO-BASED CARPET MATERIALS

(75) Inventors: Randall C. Jenkines, Dalton, GA (US); Thomas H. Perry, JR., Dalton, GA (US)

Correspondence Address: The Dow Chemical Company, Intellectual Property Section, P.O. Box 1967, Midland, MI, 48641-1967, US

(73) Assignee: Dow Global Technologies Inc., Midland, MI (US)

(21) Appl. No.: 12/518,648

(22) PCT Filed: Dec. 7, 2007
(86) PCT No.: PCT/US07/86716

§ 371 Date: Dec. 14, 2009

Related U.S. Application Data
(60) Provisional application No. 60/874,054, filed on Dec. 11, 2006.

(51) Int. Cl. B32B 3/26; B05D 3/02; A41G 1/00

(52) U.S. Cl. 428/17; 427/385.5; 428/96

(57) ABSTRACT

The present invention disclosures the use of castor oil and castor oil derivatives for use in polyurethane formulations for the production of products for the carpet industry. Process for the production of such products is also disclosed.

The present invention relates to the use of castor oil and/or castor oil derivatives for use in the production of polyurethane products for the carpet industry.

### BACKGROUND OF THE INVENTION

Many commercial carpet products have an attached polyurethane backing. Methods for making these carpets are described in, for example, U.S. Pat. Nos. 3,849,156; 4,296,159; 4,336,089; 4,405,393; 4,483,894; 4,611,044; 4,696,849; 4,853,054; 4,853,280; 5,104,693; 5,646,195; 6,140,381; 6,372,810 and 6,790,872. Polyurethane foam pads may also be used as the underlay for the carpet.

The design and construction of these carpet products can vary significantly depending on specific end-use applications and market segments. Polyurethane backings accordingly perform different functions in these various types of products. The different types of polyurethane carpet backings include precoats, unitary coatings, laminate or tie-coatings, foam coatings and hard back capped coatings.

A polyurethane precoat is the first coating which is applied to a carpet. Its function is to provide face fiber strength properties, liquid barrier properties, and flame retardancy properties. A laminate or tie-coating serves to attach a secondary fabric or glass fabric reinforcement to a carpet. In addition to serving as an adhesive, the laminate coating also provides delamination strength resistance, liquid barrier properties and dimensional stability to the carpet.

A polyurethane foam coating is usually applied to the precoat and replaces the laminate or tie-coating. Its function is to provide cushioning and comfort under foot. Tie-coats and hard back cap coatings are used in carpet tile (modular) products. The tie-coat serves to tie a fiber glass fabric to the precoated tile. A hard back cap coat in carpet tile serves as the wear-layer for the carpet tile.

The polyols used in the production the polyurethane are generally petroleum based. Presently there is an interest in using polyols obtained from renewable resources, such as vegetable oils, in the production of polyurethane products. Many of the efforts on the use of a vegetable oil have focused on obtaining polyols from soy bean oil. See for example, U.S. Pat. Nos. 6,107,433; 6,962,636; 6,979,477; 7,063,877 and 7,084,230. The use of soy bean oil in the production of polyurethanes generally requires modification of the oil for effective reactivity, functionality etc. for use in a formulation for a polyurethane. Polyols based on vegetable oil generally contain an odor and release volatile organic chemicals which limits their use in textile applications. Further chemical processes are needed to eliminate these undesirable by-products which adds additional conversion costs.

It would therefore be advantageous to utilize an oil from a renewable resource which requires no or minimal modification for use as a polyol in polyurethane formulations. It would also be desirable to be able to utilize such materials in formulations which can meet the requirement for the carpet and turf industry's economic, performance and environmental needs. It would also be desirable to utilize an oil from a renewable resource which avoid the odor issues normally associated with vegetable oil based products.

### SUMMARY OF THE INVENTION

It has been found under appropriate processing conditions, castor oil can be used to replace a substantially portion of conventional polyols in formulations for carpet backing or as a flexible foam for carpet underlay. It as also been found, modified castor oil under appropriate processing conditions can be used to replace a substantial portion of conventional polyols used in formulations for precoat applications in the carpet industry.

In one embodiment, the present invention is a process for preparing a foam backed textile or an unattached padding or underlay comprising the steps of
A) forming a polyurethane-forming composition comprising
   i) a polyisocyanate
   ii) a polyol,
   iii) from 0.0 to 4 weight percent water based on ii);
   iv) from 0.5 to 2.5 weight percent surfactant based on ii);
B) mechanically frothing the polyurethane-forming composition;
C) applying the frothed composition of step B) to a substrate or release capable belt;
D) heating the composition to a temperature from 80 to 180° C. to cure the composition and form a polyurethane layer bonded to the substrate;

wherein the polyol comprises from 5 to 60 weight percent of castor oil, castor oil derivative, or a combination thereof and the remaining polyol is a polyol or polyol blend having a nominal functionality of 2 to 3 and a hydroxyl number of 5.6 to 70.

In another embodiment the present invention is a process for preparing a carpet material comprising providing tufts, a primary backing material, and a pre-coat

engaging the tufts and the primary backing thereby forming greige goods having a top and bottom surface;

applying the pre-coat onto the bottom surface of the greige goods; and optionally curing the pre-coat,

wherein the precoat/laminate or tie-/tie-coating comprises
a) a polyisocyanate and
b) a polyol wherein the polyols comprises from 5 to 80 weight percent of a modified castor oil having a nominal functionality of 1.8 to 2.5 and the remainder of the polyol is a polyol or polyol blend having a nominal functional of 1.8 to 2.5 and a hydroxyl number of 5.6 to 70.

In another embodiment, the invention is a process comprising
a) forming a frothed polyurethane-forming composition;
b) forming a layer of frothed composition between a substrate and a containment layer;
c) curing the frothed composition to form a foamed polyurethane cushion bonded to the substrate or to both the substrate and containment layer;
   wherein the frothed polyurethane forming composition comprises

i) a polyisocyanate

ii) a polyol,

iii) from 0.0 to 4 weight percent water based on ii);

iv) from 0.5 to 2.5 weight percent surfactant based on ii);

wherein the polyol comprises from 5 to 60 weight percent of castor oil, castor oil derivative, or a combination thereof and the remaining polyol is a polyol or polyol blend having a nominal functionality of 2 to 3 and a hydroxyl number of 5.6 to 70.

In a further embodiment, the invention is an article made by any of the above described processes.

In another embodiment, the invention is a carpet having a polyurethane backing wherein the backing is a polyurethane precoat, a polyurethane laminate or tie-coat, or a polyurethane foam backing wherein the formulation used in preparing the backing contains from 5 to 80 weight percent of castor oil, a castor oil derivative, or a combination thereof as the polyol component.

### DETAILED DESCRIPTION

The present invention provides for the use of castor oil and/or a castor oil derivative in the formulations for the production of a polyurethane backed textile, in formulations for a polyurethane carpet underlayment and in formulations for carpet precoats and laminate or tie-coats and foam coatings. The use of castor oil and its derivatives provides for an inexpensive renewable resource to be used in the production of polyurethane products and avoids the odors and volatile organic compounds commonly associated with vegetable oils. It has also been found these products are readily miscible with conventional polyols used in polyurethane formulations as no phase separation is observed during storage. It has also been unexpectedly found the addition of castor oil to a conventional polyol reduces the viscosity of the overall formulation and the viscosity is lower than if another natural oil based polyol is used. This is surprising as castor oil or castor oil derivatives generally have a higher viscosity than other vegetable oils.

The formulations for producing the polyurethane contain at least a polyol, and isocyanate and castor oil and/or a castor oil derivative.

Polyols, as used herein, refers to polyols other than castor oil or castor oil derivates. Such polyols useful in the present invention are compounds which contain two or more isocyanate reactive groups, generally active-hydrogen groups, such as —OH, primary or secondary amines, and —SH. Representative of suitable polyols are generally known and are described in the art. Representative of suitable polyols include polyester, polylactone, polyether, polyolefin, polycarbonate polyols, and various other polyols. Of these, secondary amines and hydroxyl groups are preferred due to their reactivity. More preferred are hydroxyl groups based on the production cost and reactivity of such material.

Linear or branched polyols having 2 or more functional groups can be used as polyols. Generally the polyol will have a functionality of less than 6. Preferably the polyol or blend of polyols will have a nominal functionality of from 2 to 4. Preferably the polyol or polyol blend will have a nominal functionality of from 2 to 4.

The polyol will generally have a hydroxyl equivalent weight of at least 750. Preferably the polyol has an equivalent weight of at least 1000. More preferably the polyol will have an equivalent weight of at least 1200. Generally the polyol will have a hydroxyl equivalent weight of 10000 or less. Preferably the polyol will have an equivalent weight of less than 7500. More preferably the polyol has an equivalent weight of less than 5000.

The “nominal” functionality is the number of functional groups expected to be present on the polyol based on the composition of the starting materials. The actual functionality is sometimes somewhat lower, especially with polyether polyols which tend to contain some terminal unsaturation that reduces average functionality somewhat.

Preferred polyols are polyether polyols, such as a polymer of ethylene oxide (EO), propylene oxide (PO), tetrahydrofuran or butylene oxide, or a mixture of two or more of these. Particularly suitable polyether polyols include polymers of propylene oxide, random copolymers of propylene oxide and ethylene oxide, especially those containing up to about 15% by weight randomly polymerized ethylene oxide, and oxyethylene-capped polymers of propylene oxide or propylene oxide-ethylene oxide random copolymers. Preferably the polyol has less than 20 wt % EO. These polyols are conveniently prepared by adding the corresponding alkylene oxide to an initiator material such as a low molecular weight compound containing two or more hydroxyl and/or primary or secondary amine groups. Preferred polyols have mainly secondary hydroxyl groups, such as at least 70%, 80%, 90% or 98% secondary hydroxyl groups. Secondary groups tend to react with polyisocyanates more slowly than do primary hydroxyl groups, and may be selected to further help to delay the onset of reaction as the composition is mixed, frothed and applied. Particularly suitable polyether polyols are polymers of propylene oxide, which may contain up to 20% by weight terminal poly(ethylene oxide) blocks, random copolymers of propylene oxide and up to about 15% by weight ethylene oxide, poly(tetramethylene oxide) polymers and poly(butylene oxide) polymers.

Examples of initiator molecules include water, ammonia, aniline or polyhydric alcohols such as dihyric alcohols having a molecular weight of 62-399, especially the alkane polyols such as ethylene glycol, propylene glycol, hexamethylene diol, glycerol, trimethylol propane or trimethylol ethane, or the low molecular weight alcohols containing ether groups such as diethylene glycol, triethylene glycol, dipropylene glycol or tripropylene glycol. Other commonly used initiators include pentaerythritol, xylitol, arabitol, sorbitol mannitol and the like. Preferably a poly(propylene oxide) polyols include poly(oxypropylene-oxyethylene) polyols is used. These polyols are conventional materials prepared by conventional methods.

Illustrative of the polyester polyols are the poly(alkylene alkanedioate) glycols that are prepared via a conventional esterification process using a molar excess of an aliphatic glycol with relation to an alkanedioic acid. Illustrative of the glycols that can be employed to prepare the polyesters are ethylene glycol, diethylene glycol, propylene glycol, dipropylene glycol, 1,3-propanediol, 1,4-butanediol and other butanediols, 1,5-pentanediol and other pentane diols, hexanediols, decanediols, dodecanediols and the like. Preferably the aliphatic glycol contains from 2 to about 8 carbon atoms. Illustrative of the dioic acids that may be used to prepare the polyesters are maleic acid, malonic acid, succinic acid, glutaric acid, adipic acid, 2-methyl-1,6-hexanoic acid, pimelic acid, suberic acid, dodecanedioic acids, and the like. Preferably the alkanedioic acids contain from 4 to 12 carbon atoms. Illustrative of the polyester polyols are poly(hexanediol adipate), poly(butylene glycol adipate), poly(ethylene glycol adipate), poly(diethylene glycol adipate), poly(hexanediol oxalate), poly(ethylene glycol sebecate), and the like.

Polylactone polyols useful in the practice of this invention are the di- or tri- or tetra-hydroxyl in nature. Such polyol are prepared by the reaction of a lactone monomer; illustrative of which is δ-valerolactone, ε-caprolactone, E-methyl-ξ-caprolactone, 4-enantholactone, and the like; is reacted with an initiator that has active hydrogen-containing groups; illustrative of which is ethylene glycol, diethylene glycol, propanediols, 1,4-butanediol, 1,6-hexanediol, trimethylolpropane, and the like. The production of such polyols is known in the art, see, for example, U.S. Pat. Nos. 3,169,945, 3,248,417, 3,021,309 to 3,021,317. The preferred lactone polyols are the di-, tri-, and tetra-hydroxyl functional ε-caprolactone polyols known as polycaprolactone polyols.

Other polyether polyols include the poly(tetramethylene oxide) polyols, also known as poly(oxytetramethylene)glycol, that are commercially available as diols. These polyols are prepared from the cationic ring-opening of tetrahydrofuran and termination with water as described in Dreyfuss, P. and M. P. Dreyfuss, Adv. Chem. Series, 91, 335 (1969).

Polycarbonate containing hydroxyl groups include those known per se such as the products obtained from the reaction of diols such as propanediol-(1,3), butanediols-(1,4) and/or hexanediol-(1,6), diethylene glycol, triethylene glycol or tetraethylene glycol with diarylcarbonates, e.g. diphenylcarbonate or phosgene.

Illustrative of the various other polyols suitable for use in this invention are the styrene/allyl alcohol copolymers; alkoxylated adducts of dimethylol dicyclopentadiene; vinyl chloride/vinyl acetate/vinyl alcohol copolymers; vinyl chloride/vinyl acetate/hydroxypropyl acrylate copolymers, copolymers of 2-hydroxyethylacrylate, ethyl acrylate, and/or butyl acrylate or 2-ethylhexyl acrylate; copolymers of hydroxypropyl acrylate, ethyl acrylate, and/or butyl acrylate or 2-ethylhexylacrylate, and the like.

The polyurethane-forming composition includes a polyisocyanate component and a polyol component. The polyisocyanate component includes at least one organic polyisocyanate, which may be an aromatic, cycloaliphatic, or aliphatic isocyanate. Examples of suitable polyisocyanates include m-phenylene diisocyanate, tolylene-2-4-diisocyanate, tolylene-2-6-diisocyanate, hexamethylene-1,6-diisocyanate, tetramethylene-1,4-diisocyanate, cyclohexane-1,4-diisocyanate, hexahydrotolylene diisocyanate, naphthylene-1,5-diisocyanate, methoxyphenyl-2,4-diisocyanate, diphenylmethane-4,4′-diisocyanate, 4,4′-biphenylene diisocyanate, 3,3′-dimethoxy-4,4′-biphenyl diisocyanate, 3,3′-dimethyl-4-4′-biphenyl diisocyanate, 3,3′-dimethyldiphenyl methane-4,4′-diisocyanate, 4,4′,4″-triphenyl methane triisocyanate, a polymethylene polyphenylisocyanate (PMDI), tolylene-2,4,6-triisocyanate and 4,4′-dimethyldiphenylmethane-2,2′,5,5′-tetraisocyanate. Preferably the polyisocyanate is diphenylmethane-4,4′-diisocyanate, diphenylmethane-2,4′-diisocyanate, PMDI, tolylene-2-4-diisocyanate, tolylene-2-6-diisocyanate or mixtures thereof. Diphenylmethane-4,4′-diisocyanate, diphenylmethane-2,4′-diisocyanate and mixtures thereof are generically referred to as MDI, and all can be used. Tolylene-2,4-diisocyanate, tolylene-2,6-diisocyanate and mixtures thereof are generically referred to as TDI, and all can be used. Polyisocyanate compounds or mixtures thereof having from about 1.8 to about 2.5 isocyanate groups/molecule, on average, are preferred, especially those having an average of about 1.9 to about 2.3 isocyanate-groups/molecule. Prepolymers made by reacting a stoichiometric excess of any of the foregoing polyisocyanates with an isocyanate-reactive compound such as those described below can be used as well. Suitable prepolymers include soft segment prepolymers as described in U.S. Pat. No. 5,104,693 and hard segment prepolymers as described in U.S. Pat. No. 6,372,810.

In general soft segment prepolymers is the reaction product of an excess polyisocyanate, preferable MDI or a derivative thereof, and a polyol having an equivalent weight from about 500 to about 5,000 and the prepolymer having an NCO content of about 10 to about 30% by weight. In general, for a hard segment prepolymer, the polyol will have a molecular weight below 500, and preferably the polyol is a diol.

The polyol will include as part of the polyol component castor oil, a castor oil derivative or a combination thereof. Castor oil and castor oil derivatives are products which are readily available commercially. For example, various grades of castor oil and derivatives are available from Kisan Agro Product Industries, Jayant Agro Organics Ltd., Mahyco Seeds Ltd., Shyam Industries, Vertellus and others. Castor oil can generally be considered to be a mixture of about 70 wt % glyceryl triricinoleate and 30% glyceryl diricinoleate-monooleate or monolinoleate plus some minor constituents. Castor oil as used herein includes such a natural mixture or where the oil has been further refined to increase the content of the 3 functional material and reduce its natural water content such as castor oil low moisture (COLM). A typical derivative of castor oil includes esterification of castor oil, and particularly ricinoleic acid. To obtain reduction of unit weight per hydroxyl group and increased reactivity, ricinoleic or 12-hydroxyoleic acid can be reacted with dihydric alcohols to give monoesters having a nominal functionality of two. Such processes can produce di-functional materials having a wide range of hydroxyl equivalent weights, ie from 100 to 300 depending on the type of dihydric alcohol. Transesterification can also be used to decrease the unit weight per hydroxyl group. For example, transesterification of castor oil with glycerol can give corresponding mono- and di-glyceride products. Therefore the conversion of castor oil components into castor oil derivatives can be varied and many.

For use of such material in polyurethane applications, it is generally preferred the oil have a moisture content of 0.3 wt percent or less. It is also preferred to use an oil which is low in acidity, i.e. an acid of less than 3, clear, and nearly colorless. Such grades as Commercial, First Special and Pale Pressed (available from Jayant Agro-Organics Ltd.) are examples of this type of castor oil.

The formulations for making the polyurethane will generally contain at least 5 wt % of the castor oil and/or derivative based on the total polyol component, that is the total weight of the castor oil and/or derivative plus other polyol. The castor oil and/or derivative can comprise up to 10 wt %, up to 15 wt % or even at least 20 wt % of the total polyol component. Generally the amount of castor oil and/or derivative will be less than 80 wt % of the polyol. In other embodiments, the amount of castor oil and/or derivative will be less than 70 wt %, preferably less than 60 wt % of the polyol in the formulation. The amount of the castor oil and/or derivative used will also depend on the end-use applications. Generally for use in formulations for a carpet backing or carpet underlayment, the formulations will generally contain less than 60 wt % of the total polyols as castor and/or derivatives.

When the polyurethane formulation is for the production of an attached polyurethane foam cushion or a separate carpet underlay, the functionality of the castor oil or derivatives is not critical. Generally the functionality of the total polyol component, will have a nominal functionality of about 2.2 to about 3.2. When the polyurethane backing is substantially non-cellular, as in a precoat, unitary or laminate or tie-layer, it is preferably formulated with careful control of the functionality of the components, as described in 4,296,159. By selecting components having an actual average functionality of very close to 2.0, a more dimensionally stable product can be obtained.

The polyurethane-forming composition also preferably contains one or more catalysts, which promote the reaction of the polyisocyanate with the isocyanate-reactive materials. Suitable catalysts include tertiary amines, organometallic compounds, or mixtures thereof. Specific examples of organometallic catalysts include di-n-butyl tin bis(mercaptoacetic acid isooctyl ester), dimethyltin dilaurate, dibutyltin dilaurate, dibutyltin diacetate, dibutyltin sulfide, stannous octoate, lead octoate, nickel acetylacetonate, ferric acetylacetonate, and bismuth carboxylates. Preferred are nickel acetylacetonate and bibutyltin sulfide or a combination of the two. Example of tertiary amine catalysts include, alkylmorpholines, including N-methyl morpholine, 1,4-dimethylpeperazine, triethylene diamine, bis(N,N-dimethylaminoethyl)ether, and N,N,N′N′-tetramethyl-1,3-butanediamine. An amine-blocked tin (IV) catalyst, such as those described in U.S. Pat. No. 5,491,174, can be used. The use of delayed action catalyst such as those described in U.S. Pat. Nos. 4,611,044 and 5,646,195 is often preferred. An amount of catalyst is advantageously employed such that a relatively rapid cure to a tack-free state can be obtained, while providing enough open time that the polyurethane composition can be dispensed and spread over the carpet back before curing. If an organometallic catalyst is employed, such a cure can be obtained using from about 0.001 to about 2.0 parts per 100 parts of the polyurethane-forming composition, by weight. If a tertiary amine catalyst is employed, the catalyst preferably provides a suitable cure using from about 0.01 to about 3 parts of tertiary amine catalyst per 100 parts of the polyurethane-forming composition, by weight.

Particularly suitable components of a polyol mixture, in addition to the polyol described before, include a chain extender or crosslinker. For purposes of this invention, a chain extender is a material having two isocyanate-reactive groups/molecule and an equivalent weight per isocyanate-reactive group of from about 30 to 400. A crosslinker, for purposes of this invention, is a compound having three or more isocyanate reactive groups and an equivalent weight per isocyanate-reactive group of 150 or less. The isocyanate-reactive groups may be hydroxyl, primary amine or secondary amine groups. Chain extenders and crosslinkers having hydroxyl groups are preferred because hydroxyl groups react more slowly and thus provide more time to apply and gauge the polyurethane-forming layer. Examples of suitable chain extenders include ethylene glycol, diethylene glycol, triethylene glycol, propylene glycol, dipropylene glycol, tripropylene glycol, 1,4-dimethylolcyclohexane, diethyltoluene diamine, 1,4-butane diol, 1,6-hexane diol, 1,3-propane diol, amine-terminated polyethers such as Jeffamine D-400 from Huntsman Chemical Company, amino ethyl piperazine, 2-methyl piperazine, 1,5-diamino-3-methyl-pentane, isophorone diamine, ethylene diamine, hexane diamine, hydrazine, piperazine, mixtures thereof and the like. Amine chain extenders can be blocked, encapsulated, or otherwise rendered less reactive in order to reduce the reactivity of the formulation and provide more working time to apply and gauge the foam layer. Chain extenders advantageously constitute up to about 30%, especially up to about 20% of the total weight of the polyol mixture.

The polyurethane-forming composition can contain a filler, which reduces overall cost and may improve flame resistance, firmness and other physical properties. The filler may be present in an amount from about 5 to about 1000 parts by weight per 100 parts by weight isocyanate-reactive materials. Suitable fillers include talc, mica, montmorillonite, marble, barium sulfate (barytes), milled glass granite, milled glass, calcium carbonate, aluminum trihydrate, carbon, aramid, silica, silica-alumina, zirconia, talc, bentonite, antimony trioxide, kaolin, coal based fly ash and boron nitride. The filler is present in the form of finely divided particles. Particle size may range widely from as little as 10 nm to as much as 250 microns.

If an attached cushion is to be applied to a substrate, or if an unattached cushion pad or carpet underlay is made by a tenter or belted process, the polyurethane-forming composition will also include at least one surfactant, which serves to stabilize the foam bubbles until the composition has cured to form a foam. Typically about 0.5 to about 3 parts of a surfactant is used per 100 parts by weight polyol or polyol mixture.

Suitable surfactants include silicone and block copolymers of ethylene oxide and silicone surfactants. For example, suitable block copolymers of ethylene oxide include copolymers having at least 60 weight percent of the polymer being derived from oxyethylene units, 15 to 40 weight percent of the polymer being derived from polydimethylsiloxane units, and the polymer having a molecular weight of less than 30,000 as described in U.S. Pat. No. 4,483,894. Other suitable surfactants are linear siloxane-polyoxyalkylene bock copolymers having an average molecular weight of at least 30,000 as disclosed in U.S. Pat. No. 4,022,722, the disclosure of which incorporated herein by reference. A surfactant can be included in a formulation of the present invention an amount ranging from about 0.01 to about 2 parts per 100 parts by weight of polyol.

When preparing a polyurethane precoat or polyurethane laminate tie-coat, a surfactant is generally not added.

Similarly, the polyurethane-forming composition may include water or a physical blowing agent, in order to provide some supplemental blowing and added expansion, in cases where an attached cushion is to be applied. Water is preferred and if used is suitably present in an amount of at least 0.25 part by weight per 100 parts by weight of the polyol. Suitable amounts are from 0.5 to about 4.0 parts of water per 100 parts by weight polyol, especially from 0.6 to 3.0 parts by weight of water per 100 parts by weight polyol.

Generally when used, the blowing agent is used in an amount sufficient to provide the desired density to the polyurethane. In general, in mechanically frothed foam systems, the polyurethane will have a density from about 12 to about 50 pounds per cubic foot (192 to 800 Kg/m³), preferably about 12 to about 35 (192.2 to 567 Kg/m³), and more preferably about 12 to about 20 pounds per cubic foot (192 to 320 Kg/m³) when frothed with a gas. In the mechanically frothed chemically blown systems, the polyurethane will have a density of from about 3 to about 15, preferably from 4 to about 12 pounds per cubic foot (40 to 240 and 64 to 192 Kg/m³ respectively). More preferably such a foam will have a density of from 5 to 10 pounds per cubic foot (80 to 160 Kg/m³).

Other additives may be used, including fire retardants, pigments, antistatic agents, reinforcing fibers, antioxidants, preservatives, acid scavengers, thixotropes, and the like.

A wide variety of materials can function as the substrate, including, for example, polymeric films or sheets, carpet (including pile yarn carpet), textile fabrics, artificial turf, paper sheets, rigid materials such as wood, veneers, metal foils or sheets, or composites, among many others.

A substrate of particular interest is a tufted or woven carpet material. The carpet includes a primary backing that defines multiple openings through which a facing fiber is tufted or woven to produce a carpet face. The primary backing is generally in the form of a woven or nonwoven scrim, and can be made of any convenient material, such as, for example, jute, polypropylene, nylon, a polyester, a polyacrylate, cotton, wool, or other material. The facing fiber also can be of any convenient material, such as wool, cotton, nylon, a polyester, an acrylic fiber, polypropylene, polyethylene, a blend of any two or more of these, or the like. The facing fiber is typically in the form of fiber bundles that are tufted or woven through the primary backing to produce a carpet face and an opposing underside. In one embodiment, a non-cellular polyurethane is applied in accordance with the invention to form a non-cellular backing, such as a precoat, laminate or tie-, unitary, tie-coat or hard back cap coating. Alternatively or additionally, a cellular polyurethane cushion can be attached to the carpet in accordance with the invention.

General methods for applying a polyurethane composition to a substrate are well-known and described, for example, in U.S. Pat. Nos. 3,849,156, 4,296,159, 4,336,089, 4,405,393, 4,483,894, 4,611,044, 4,696,849, 4,853,054, 4,853,280, 5,104,693, 5,646,195, 6,140,381, 6,372,810 and 6,790,872. The general methods described there are applicable to this invention. The main processing steps are the blending of all the components, including surfactants (if used) and the catalysts; frothing, dispensing, and gauging.

It is usually convenient to form a partially formulated polyol component beforehand. The component includes the polyol mixture, filler, and viscosity depressant. The formulated polyol component is blended with the polyisocyanate immediately prior to dispensing (or frothing, in cases where the composition is frothed). The surfactant (when used) can be added into the formulated polyol, added simultaneously with the polyisocyanate, or added during frothing step. The catalyst package can be added into the formulated polyol, added simultaneously with the polyisocyanate, or added during or after the frothing step. It is generally desired to delay adding the catalyst as long as possible in order to maximize the time that is available to complete the remaining process steps prior to cure. When the catalyst is added after the frothing step, the froth and catalyst are advantageously passed through a static mixing device (such as a Chemineer-Kenics mixer, TAH mixer or other motionless mixing device), in order to more uniformly blend the components. A static or motionless mixer tends not to significantly degrade the froth or the distribution of the frothing gas within the froth.

It is preferred to froth the polyurethane-forming composition prior to dispensing and gauging it, even when a substantially non-cellular backing is applied. Frothing the composition increases the volume of the composition and thus makes it easier to dispense and gauge accurately. In these cases such as precoat and laminate/tie-coating, the composition preferably contains very little or no surfactant that can stabilize the gas bubbles that are formed in the frothing step. This allows the bubbles to collapse and the frothing gas to escape during or after the gauging step, so a non-cellular polyurethane is produced optimizing carpet backing physical properties such as tuftbind, edge ravel, delamination strength, and the castor chair test.

If a cellular attached cushion or unattached padding or cushion underlay are to be formed, the polyurethane-forming composition must be frothed and blown with water (or other blowing agent) if lower density foam is desired. It is possible to use a combination of frothing and blowing techniques to obtain cushion densities less than 15 lb/ft². In this technique the composition is frothed to a cup weight of 300-450 g/l and then water either formulated into the compound or side-added prior to the frothing step is added to assist the density reduction. In these cases the froth must be covered with an impermeable substrate like film (in a belted or tenter processes) or precoated carpet or film (in a belt process) to trap the gas prior to cure.

The composition is frothed by whipping, air, nitrogen, argon or other gas into it before it is dispensed and applied, using any convenient apparatus such as an Oakes mixer, a Lessco mixer or a Hansa Frothing Unit. Methods of preparing such a mechanically frothed mixture are described in U.S. Pat. Nos. 4,853,054, 5,104,693, 5,908,701, 6,040,381, 6,096,401 and 6,555,199, all incorporated herein by reference. The polyurethane-forming composition is generally frothed to a froth density of about 300 to 600, especially from 400 to 500, grams/liter prior to application.

The resulting polyurethane-forming composition, whether frothed or not, is dispensed to form a puddle on one side of the substrate. The puddle is formed into a layer of the desired thickness or coating weight, and the assembly is then heated to complete the cure. A variety of equipment types are suitable for dispensing the polyurethane-forming composition and forming it into a layer. A preferred method of dispensing the composition is through a traversing dispensing nozzle hose or head, which travels back and forth across the substrate to dispense the composition more or less evenly across the width of the surface of the substrate. The composition is suitably dispensed upstream of a doctor blade or roller, which gauges the composition to a desired thickness and helps to force the composition onto the surface of the substrate. Another suitable apparatus for forming the polyurethane-forming composition into a layer and gauging it is an air knife.

Alternatively, the composition may be formed into a layer on a moving belt (such as a Teflon belt or a release layer) or other suitable apparatus then drop in the film or carpet on top of the froth. After application, gauging, and substrate marrying the layer is cured, advantageously through the application of heat such as by heating plates, a convention oven, an infrared oven or other suitable apparatus. A cure temperature of about 100° C. to about 170° C. for a period of about 1 to about 120 minutes is suitable. As is apparent, the cure time is dependent on the temperature.

In some applications, it is desirable to coat both sides of the substrate with polyurethane, as in preparing carpet underlayment. This is easily done by coating one surface of the substrate, turning it over and then coating the opposite surface. Multiple layers of polyurethane can be applied to the substrate if desired. In addition, multiple layers of substrate can be used. For example, a second substrate can be laid atop the curing polyurethane layer, so that when the polyurethane has cured, a sandwich structure having an intermediate polyurethane layer is obtained. Of particular interest are carpet sandwich structures having a topmost carpet face, an intermediate polyurethane foam layer, and a bottommost release layer of a nonwoven scrim, as describe in U.S. Pat. No. 4,853,280, the disclosure of which is incorporated herein by reference.

The composition is suitably applied at a coating weight of from about 10 to about 70 ounces/square yard (0.33-2.31 kg/m²), and in particular from about 15 to about 30 ounces per square yard (0.49-0.99 kg/m²). The thickness of the applied layer, when applied as a froth, is generally from about 0.05 to about 1.0 inches (0.13-2.54 cm), preferably from about 0.1 to about 0.625 inch (0.26-0.1.59 cm). If the cells of a froth are not stabilized, the applied layer will usually collapse after it passes under the doctor blade or air knife or in the oven to form a thinner layer. When the composition contains a surfactant, the thickness of the layer after gauging will be close to or the same as the thickness of the layer as applied and gauged in non-water systems; and about 4× thicker in mechanically frothed and chemically blown systems.

The carpet backings of the invention have particular applicability in the residential and commercial carpet industry as well as in carpeting for recreational use, such as boats, cars, patios, synthetic tuft, etc.

The following examples illustrate the present invention but are not intended to limit the scope thereof. All parts and percentages are by weight unless otherwise indicated. Unless stated otherwise, all molecular weights expressed herein are weight average molecular weight.

Celceram PV20A is a coal based fly ash available from Boral Industries.

Code 5027 is an ethoxylated dodecylnol phosphate ester, a viscosity depressant, a product of Fibro Chem. Inc.

ISONATE* PR 7045 is an isocyanate containing 50% wt % of a 23 wt % NCO prepolymer prepared from VORANOL* 4703 (a glycerin initiated PO polyol containing a 17.4 wt % E0 end-cap, 1650 equivalent weight) polyol and M 124 MDI (4,4′-MDI) and 50 wt % of PAPI* 7940 isocyanate, all available from The Dow Chemical Company.

ISONATE PR 7594 isocyanate is a dipropylene glycol/tripropylene glycol hard segment prepolymer/polymeric MDI blend (50/50 wt %) of ISONATE 7500A_isocyanate (hard segment prepolymer prepared from 4,4′-MDI and DPG/TPG) and PAPI 7940 isocyanate, all available from The Dow Chemical Company.

PAPI 7940 isocyanate is a mixture of polyphenylene polyaromatic polyisocyanate (40 wt %), 2,3 functional, 32 wt % NCO, and MDI (60 wt %; 14 wt % 2,4′-MDI).

UL2 is Fomrez UL2, a dibutyl tin dicarboxylate catalyst available from Momentive Performance Materials.

UL6 refers to Fomrez UL6, a dibutyltin diisocytlmercaptoacetate delayed action catalyst, a product of General Electric Company.

UL29 is a tin catalyst available from General Electric Company.

VORANOL 9120A polyol is an all PO, 2000 MW diol available from The Dow Chemical Company.

Voranol 9137CA polyol is a glycerin initiated, 3000 mw polyol EO/PO heterofed polyol containing 13 wt % EO.

VORANOL 9287A polyol is a 2000 MW PO diol containing 12.7 wt % E0 end-cap, available from The Dow Chemical Company.

VORANOL 9741A polyol is a glycerin initiated PO containing 13 wt % E0 end-cap, 4800 MW, available from The Dow Chemical Company.

VORANOL SH9100A polyol is an aniline initiated 2 mol PO/moleNH of PO; used as a chain extender.
ISONATE, PAPI AND VORANOL are all trademarks of The Dow Chemical Company.

### EXAMPLE 1

### Use of Castor Oil in Mechanically Froth Foam Attached Cushion Carpet Backing

A 2 inch Oakes frother equipped to process multi-component streams is used to prepare a mechanically froth foam formulation containing castor oil for applying a foam to a polyurethane precoated carpet style Certificate (RTM of J&J Industries, Inc.), nylon 6.6 face tufted through a woven polypropylene primary layer. The formulation is prepared by mixing with a 10 cm cowles blade: 2634 g VORANOL 9741A polyol; 2634 g castor oil low moisture (COLM); 293 g diethylene glycol, and 6439 g D 70 CaCO₃ (available from Imerys). This mixture is referred to as the compound. The castor oil is obtained from Jayant Agro-Organics Ltd. The mixture is blended to a temperature of 49° C., poured into a 20 liter pressurized Binks™ tank and cooled to about 18.3° C.

Into separate vessels are added the following components: ISONATE PR 7045 isocyanate is added to a 41 pressurized tank, a blend of 25 wt % Niax™ L5614 surfactant (Niax is a trademark of General Electric Company) in VORANOL 9287A polyol is added to a 1 l tank; and a blend of Fomrez™ UL 29 catalyst in VORANOL 9287A polyol is added to another 1 l tank. The materials are feed into the Oakes frother at the following feed rates: 205 g/min compound, 44.4 g/min isocyanate, 4.0 g/min surfactant blend, and 1.5 g/min catalyst blend. The ingredients are mixed and frothed with 0.33 l/min compressed air to a froth density of 400 g/l. The frothed foam is delivered via hose to the backside of the carpet. The froth is applied to precoated carpet using a blade over bedplate gapped at 3.2 mm. A 0.08 kg/m² nonwoven polyester scrim is laid onto the surface of the froth and the carpet composite is cured in a 135° C. forced air oven for 6 minutes and then cooled to a temperature of 25° C. Table 1 shows the ASTM testing results for comparative samples C1, C2, & C3 and examples 1, 2 & 3. Comparative samples C1, C2 & C3 are made using a formulation where the polyol blend is made with 6429 g VORANOL 9741A polyol and 714 g diethylene glycol with all the other components remaining the same as described above for the working examples. Comparative example C2 and example 2 are tested for physical properties after being subjected to 12500 castor chair cycles and comparative sample C3 and example 3 were tested for physical properties after being subjected to 25000 castor chair cycles. The foam made with 18 wt % castor oil maintained adequate physical properties even after being subjected to extreme fatigue from the castor chair testing device.

TABLE 1

| | | Example | | | | | |
|---|---|---|---|---|---|---|---|
| | Test methods | C1 | C2 | C3 | Example 1 | Example 2 | Example 3 |
| Castor oil, % | | 0.0 | | | 18.0 | | |
| (based on filled | | | | | | | |
| polymer) | | | | | | | |
| Compound Viscosity | Brookfield | 7200.0 | | | 4500.0 | | |
| #6@20, cp RT | viscometer | | | | | | |
| Cure time¹, min at | Tongue | 2.0 | | | 2.5 | | |
| 130 C. | depressor | | | | | | |
| Gel time², min | Brookfield | 8.2 | | | 13.5 | | |
| | viscometer | | | | | | |
| Froth exit | Thermometer | 28.0 | | | 33.8 | | |
| Temperature, C. | | | | | | | |
| Castor Chair Cycles | DIN 54328 | 0 | 12500 | 25000 | 0 | 12500 | 25000 |
| Foam Density, | ASTM D3676 | 331.6 | 336.3 | 358.8 | 342.8 | 341.1 | 357.2 |
| kg/m3 | | | | | | | |
| Foam thickness, | ASTM D3676 | 5.1 | 4.5 | 4.5 | 4.7 | 5.1 | 4.5 |
| mm | | | | | | | |
| 50% Compression | ASTM D3676 | 9.9 | 15.2 | 14.7 | 1.0 | 1.4 | 1.1 |
| set, % | | | | | | | |
| 25% ILD, kPa | ASTM D3574 | 113.0 | 71.0 | 53.8 | 127.5 | 44.4 | 45.8 |
| 25% CLD, kPa | ASTM D3676 | 58.6 | 42.0 | 34.5 | 72.5 | 23.4 | 27.6 |
| % CLD Retention | Initial-final/ | 0.0 | 71.7 | 58.9 | 0.0 | 32.3 | 38.1 |
| | initial*100 | | | | | | |
| 65% ILD, kPa | ASTM D3574 | 436.4 | 299.2 | 249.5 | 507.4 | 213.7 | 233.7 |
| 65% CLD, kPa | ASTM D3676 | 336.0 | 204.7 | 188.9 | 392.3 | 140.0 | 177.9 |
| Ball Rebound, % | ASTM D3674 | 31.0 | 34.0 | 30.0 | 24.0 | 14.0 | 14.0 |

¹Cure time is the time when the reaction is sufficiently complete where the foam does not stick to a tongue depressor when the foam is probed.
²Gel Time is the time between the discharge of the foam ingredients and the point at which the foam has developed enough gel strength to resist light impression as and is dimensionally stable, generally about 49° C.

### EXAMPLE 4

### Use of a Bifunctional Castor Oil in a Polyurethane Precoat System

A precoat compound is made by mixing together in a plastic cup 57.5 g. of Voranol 9120A polyol; 30.0 g. of bifunctional castor oil, a material designated BFCO obtained from Jayant Agro-Organic Ltd.; 12.5 g of dipropylene glycol, and 205 g of CaCO₃ D70 from Imerys. The materials are mixed to a temperature of 49° C. and then allowed to cool to 25° C. The 305 g of compound is mixed with 58.1 g of Isonate® 7594A isocyanate and 0.45 g. of a 1.0 wt % UL6 in Voranol 9287A polyol. The catalyzed precoat formulation is deposited onto a carpet style Certificate (available from J&J Industries, Inc.) using a coating knife The carpet and applied precoat are conveyed into a lab oven and cured at 130° C. for 6 minutes. The cure carpet precoat backing is tested for selected physical properties. Table 2 shows the ASTM testing results for comparative example C4 and example 4. Comparative example C4 is made using a formulation where the polyol blend was made with 85 g. of Voranol 9120A polyol and 15 g of dipropylene glycol; all other types and amounts of the components were the same as for Example 4. The data shows a precoat formulation using a castor oil derivative gives properties comparable to a conventional system.

TABLE 2

Example
number

| | 4 | C4 |
|---|---|---|
| Compound viscosity, | 8550 | 10800 |
| cp #6@20 RT | | |
| Polyol separation | no | no |
| TF, min @130 C. 6 min | 3 | 2 |
| cure | | |
| Coating weight, Kg/m2 | 1.2 | 1.3 |
| Back Cracking | no | yes |
| Hand, kg | 4.5 | 11.8 |
| Tuftbind, Kg | 9.1 | 9.4 |
| Wet tuftbind, Kg | 8.3 | 8.5 |
| Wet retention, % | 91.1 | 90.4 |
| Edge curl, cm | 0.2 | 0.4 |
| Velcro rating | 4.5 | 4.5 |

### EXAMPLE 5

### Use of Castor Oil (#1 Imported Oil Available from Vertellus) in Polyurethane Mechanically Froth/Chemically Blown Formulation to Produce a Low Density Cushion Underlay

A 2 inch Oakes frother equipped to process multi-component streams is used to prepare a mechanically froth/chemically blown foam formulation containing castor oil. The formulation is used to manufacture a low density cushion underlay for residential padding. A compound is prepared by mixing with a 10 cm cowles blade: 5554 g VORANOL 9287A polyol, 1992 g #1 imported castor oil (Vertellus) 422 g diethylene glycol, 79.9 g of Code 5027, and 11952 g D 70 CaCO₃. The compound is blended to a temperature of 49° C., poured into a 20 l pressurized Binks™ tank and cooled to about 11.6° C. Into separate vessels are added the following components: PAPI 7940 isocyanate is added to a 41 pressurized tank; a blend of 25 wt % Niax™ L5614 surfactant in VORANOL 9287A polyol is added to a 1 l tank; a blend of 25 wt % water in VORANOL 9287A polyol is added to a 1 l tank; and a blend of 1 wt % dibutyl tin sulfide catalyst (available from Goldsmidth) in VORANOL 9287A polyol is added to another 1 l tank. The materials are feed into the Oakes frother at the following feed rates: 189 g/min compound, 46.8 g/min isocyanate, 4.5 g/min surfactant blend, 4.6 g/min water blend, and 4.5 g/min catalyst blend. The ingredients are mixed and frothed with 0.46 l/min compressed air to a froth density of 340 g/l. The frothed foam is delivered via hose to a Teflon/fiberglass belt which is preconditioned with mold release paste wax (available from Chem Trend). The froth is applied using a blade over bedplate gapped at 3.1 mm to a preconditioned Teflon/fiberglass belt. A 0.025 mm polyurethane film is laid onto the surface of the froth and cured in a 135° C. forced air oven for 6 minutes and then cooled to a temperature of 25° C. After cure, the foam/polyurethane film composite is released from the Teflon/fiberglass belt and tested for physical properties. Table 3 shows the ASTM testing results for comparative sample C5 and example 5. Comparative sample C5 is made using a formulation where the polyol blend is made with 3665 g VORANOL 9287A polyol, 3665 g VORANOL 9137CA polyol, and 637 g diethylene glycol; all other types and amounts of the components remaining the same as for example 5.

TABLE 3

Example

| | C5 | 5 |
|---|---|---|
| #1 Imported castor oil, % | 0.0 | 8.0 |
| (based on filled polymer) | | |
| Compound Viscosity | 7600.0 | 6400.0 |
| #6@20, cp 10 C. | | |
| Cure time, min at 130 C. | 2.0 | 2.0 |
| Gel time, min @32 C. | 13.5 | 17.0 |
| Froth exit Temperature, F. | 25.8 | 27.8 |
| Foam Density, kg/m3 | 118 | 121.7 |
| Foam thickness, mm | 11.6 | 11.4 |
| 50% Compression set, % | 5.8 | 5.7 |
| 25% ILD, Kpa | 27.6 | 21.3 |
| 25% CLD, Kpa | 6.2 | 5.9 |
| 65% ILD, Kpa | 91.7 | 82.9 |
| 65% CLD, Kpa | 21.3 | 20.3 |
| Ball Rebound, % | 20 | 20 |

The results show the use of castor oil in a mechanically frothed/chemically blown system produces a polyurethane with properties comparable to a conventional polyurethane system.

From the foregoing, it will be observed that numerous variations and modifications may be effected without departing from the true spirit and scope of the novel concepts of the invention.

### EXAMPLE 6

### Use of a Bifunctional Castor Oil in a Polyurethane Precoat System

A precoat compound is made by mixing together in a plastic cup 45.8 g. of Voranol 9120A polyol; 25.0 g. of bifunctional castor oil, a material designated BFCO obtained from Jayant Agro-Organic Ltd.; 15 g Voranol 9137CA polyol; 9.2 g of dipropylene glycol; 5 g of Voranol SH 9100 polyol; 1 g Code 5027; 0.3 g standard hydrated lime; and 350 g Celceram PV20A. The materials are mixed to a temperature of 49° C. and then allowed to cool to 25° C. The 451.3 g of compound is mixed with 64.9 g of Isonate® 7560 isocyanate and 1.25 g. of a 1.0 wt % dibutyl tin disulfide Voranol 9287A polyol. The catalyzed precoat formulation is deposited onto a carpet style Certificate (available from J&J Industries, Inc.) using a coating knife The carpet and applied precoat are conveyed into a lab oven and cured at 130° C. for 6 minutes. The cure carpet precoat backing is tested for selected physical properties. Table 4 shows the ASTM testing results for comparative example C6 and example 6. Comparative example C4 is made using a formulation where the polyol blend was made with 67 g. of Voranol 9120A polyol, 15 g Voranol 9137CA polyol; 5 g Voranol 9100 polyol; and 13 g of dipropylene glycol; 1 g Code 5027; and 350 g Celceram PV20A. The 451 g compound is mixed with 68.0 g Isonate 7560 isocyanate and a catalyst package consisting of 0.02 g Fomrez UL2/EDA complex and 0.007 g Fomrez UL6. The data shows a precoat formulation using a castor oil derivative gives properties comparable to a conventional system.

TABLE 4

Example
number

| | 6 | C6 |
|---|---|---|
| Compound viscosity, | 33200 | 34600 |
| cp #6@20, 15.5° C. | | |
| Polyol separation | no | no |
| TF, min @130 C. 6 min | 2 | 2 |
| cure | | |
| Coating weight, Kg/m2 | 1.22 | 1.23 |
| Back Cracking | no | no |
| Hand, kg | 6.39 | 8.71 |
| Tuftbind, Kg | 8.57 | 6.30 |
| Edge curl, cm | 0.6 | 1.3 |
| Velcro rating (1-5) | 4.5 | 4.5 |

1. A process for preparing a foam backed textile, an unattached padding or underlay comprising the steps of
A) forming a polyurethane-forming composition comprising
i) a polyisocyanate
ii) a polyol,
iii) from 0.0 to 4 weight percent water based on weight of polyol;
iv) from 0.5 to 2.5 weight percent surfactant based on weight of polyol);
B) mechanically frothing the polyurethane-forming composition;
C) applying the frothed composition of step B) to a substrate or release capable belt;
D) heating the composition to a temperature from 80 to 180° C. to cure the composition and form a polyurethane layer bonded to the substrate;
wherein the polyol comprises from 5 to 60 weight percent of castor oil, castor oil derivative, or a combination thereof and the remaining polyol is a polyol or polyol blend having a nominal functionality of 2 to 3 and a hydroxyl number of 5.6 to 70.

2. The process of claim 1 wherein the substrate is a polymeric film, a polymer sheet, carpet, textile fabric or artificial turf.

3. The process of claim 1 wherein the isocyanate is an isocyanate terminated prepolymer.

4. The process of claim 1 wherein the amount of castor oil or castor oil derivative is at least 10 weight percent of the polyol.

5. The process of claim 4 wherein the castor oil or castor oil derivatives comprises at least 15 weight percent of the polyol.

6. A process for preparing a carpet material comprising providing tufts, a primary backing material, and a pre-coat
engaging the tufts and the primary backing thereby forming greige goods having a top and bottom surface;
applying the pre-coat onto the bottom surface of the greige goods; and optionally curing the pre-coat,
wherein the precoat/laminate or tie-/tie-coating comprises
a) a polyisocyanate and
b) a polyol wherein the polyols comprises from 5 to 80 weight percent of a modified castor oil having a nominal functionality of 1.8 to 2.5 and the remainder of the polyol is a polyol or polyol blend having a nominal functional of 1.8 to 2.5 and a hydroxyl number of 5.6 to 70.

7. The process of claim 6 wherein the isocyanate is an isocyanate terminated prepolymer.

8. The process of claim 7 wherein the castor oil or castor oil derivative comprises at least 10 weight percent of the polyol.

9. The process of claim 8 wherein the castor oil or castor oil derivative comprises at least 15 weight percent of the polyol.

10. A process comprising
a) forming a frothed polyurethane-forming composition;
b) forming a layer of frothed composition between a substrate and a containment layer;
c) curing the frothed composition to form a foamed polyurethane cushion bonded to
the substrate or to both the substrate and containment layer; wherein the frothed polyurethane forming composition comprises
i) a polyisocyanate
ii) a polyol,
iii) from 0.0 to 4 weight percent water based on weight of polyol;
iv) from 0.5 to 2.5 weight percent surfactant based on weight of polyol;
wherein the polyol comprises from 5 to 60 weight percent of castor oil, castor oil derivative, or a combination thereof and the remaining polyol is a polyol or polyol blend having a nominal functionality of 2 to 3 and a hydroxyl number of 5.6 to 70.

11. The process of claim 10 wherein the substrate is a polymeric film, a polymer sheet, carpet, textile fabric or artificial turf.

12. The process of claim 10 wherein the isocyanate is an isocyanate terminated prepolymer.

13. The process of claim 1 wherein the amount of castor oil or castor oil derivative is at least 10 weight percent of the polyol.

14. The process of claim 13 wherein the castor oil or castor oil derivatives comprises at least 15 weight percent of the polyol.

15. An article made by the process of claims 10.
